(19) United States
(12) Patent Application Publication
(10) Pub. No.: US 2024/0190521 A1
(43) Pub. Date: Jun. 13, 2024

(54) VEHICLE CAPABLE OF CONTAINER SWAPPING

(71) Applicants: Hyundai Motor Company, Seoul (KR); Kia Corporation, Seoul (KR)

(72) Inventors: Jin Ho Hwang, Cheonan-si (KR); Sang Heon Lee, Seoul (KR); Dong Eun Cha, Hwaseong-si (KR); Choon Taik Kim, Yongin-si (KR); Hyung Jin Kim, Seoul (KR); Sang Hoon Lee, Asan-si (KR)

(73) Assignees: Hyundai Motor Company, Seoul (KR); Kia Corporation, Seoul (KR)

(21) Appl. No.: 18/217,775

(22) Filed: Jul. 3, 2023

(30) Foreign Application Priority Data
Dec. 7, 2022 (KR) 10-2022-0169949

(51) Int. Cl. B62D 53/06

(52) U.S. Cl. CPC B62D 53/067

(57) ABSTRACT

A vehicle capable of container swapping, includes: a container including a container body and a rotation shaft provided on a front end portion or a rear end portion thereof; and a drive module including a driving device to be able to travel, guide portions formed on a first side and a second side of the drive module, respectively, to guide the rotation shaft of the container, magnetic modules provided on peripheries around the guide portions, the drive module traveling toward the rotation shaft of the container so that the rotation shaft enters the guide portions, and the guide portions and the rotation shaft being held by holding forces from the magnetic modules so that the container is moved through traveling.

### CROSS-REFERENCE TO RELATED APPLICATION(S)

The present application claims priority to Korean Patent Application No. 10-2022-0169949, filed on Dec. 7, 2022, the entire contents of which is incorporated herein for all purposes by this reference.

### BACKGROUND OF THE PRESENT DISCLOSURE

### Field of the Present Disclosure

The present disclosure relates to a vehicle configured for container swapping, and more particularly, to a technology regarding a vehicle having a drive module which may be coupled to a container so that the drive module may be freely coupled to and decoupled from a container through a magnetic module.

### Description of Related Art

Containers, particularly ship containers which may be transported by road, are important items generally used for ships and trucks. Such a ship container has wheels disposed on the lower portion thereof, and may be configured to be pulled behind by a towing vehicle, such as a tractor trailer.

Such a trailer frequently needs to be moved backwards toward a shipping dock configured to compensate for the height of the container increased by wheels to facilitate loading and unloading of cargo. Furthermore, additional work may be necessary when loading and unloading cargo with regard to the ground, making cargo handling difficult. For example, additional equipment such as a forklift may be necessary. Such a trailer-type container may have a problem in that storage or shipping is inconvenient because of the additional structure and the need to handle a trailer component attached to the container.

Accordingly, there is a demand for a scheme for facilitating coupling and decoupling of a trailer-type container.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle configured for container swapping, the vehicle including a drive module which may be coupled to a container so that the drive module may be freely coupled to and decoupled from a container through a magnetic module.

The technical subjects pursued in an exemplary embodiment of the present disclosure may not be limited to the above mentioned technical subjects, and other technical subjects which are not mentioned may be clearly understood, through the following descriptions, by those skilled in the art to which the present disclosure pertains.

To solve the above-mentioned technical problems, the present disclosure may provide a vehicle configured for container swapping, the vehicle including: a container including a container body and a rotation shaft provided on a front end portion or a rear end portion thereof; and a drive module including a driving device to be able to travel, guide portions formed on a first side and a second side of the drive module, respectively, to guide the rotation shaft of the container, magnetic modules provided on peripheries around the guide portions, the drive module traveling toward the rotation shaft of the container so that the rotation shaft enters the guide portions, and the guide portions and the rotation shaft being held by holding forces from the magnetic modules so that the container is moved through traveling.

In an aspect of the present disclosure, when the rotation shaft enters the guide portions, the guide portions may be pressurized by the rotation shaft and rotated in a direction of entry of the rotation shaft.

In an aspect of the present disclosure, respective magnetic modules may be provided on peripheries around the guide portions to correspond to the guide portions.

In an aspect of the present disclosure, the vehicle configured for container swapping may further include a power module provided on the drive module to ascend in a longitudinal direction of the rotation shaft when being coupled to the rotation shaft, providing the holding force to the magnetic modules, and the power module may be decoupled to an armature below the power module when coupled to the rotation shaft.

In an aspect of the present disclosure, the power module may descend with the guide portions in the longitudinal direction of the rotation shaft when decoupled from the rotation shaft so that the guide portions and the rotation shaft are released.

In an aspect of the present disclosure, the rotation shaft may include an internal space formed therein, a wire is provided to penetrate the internal space, and the penetrating wire may be connected to the power module on a lower surface of the rotation shaft.

In an aspect of the present disclosure, the vehicle configured for container swapping may further include multiple guide pins provided on lateral portions of the power module to elastically support the power module upwards, and the guide pins may be configured so that the power module ascends in the longitudinal direction of the rotation shaft to be coupled to the rotation shaft.

In an aspect of the present disclosure, the guide portions may be formed in V-shapes so that first and second end portions thereof extend toward the rotation shaft.

In an aspect of the present disclosure, the guide portions may have holding grooves formed on rear surfaces thereof, and the vehicle may further include multiple holding blocks provided on peripheries around the guide portions to be fastened to the holding grooves formed on the guide portions by holding forces from the magnetic modules, constraining positions of the guide portions.

In an aspect of the present disclosure, the container may include an extension portion formed to extend from an upper portion of the front side or the rear side of the container body, the rotation shaft may extend downwards from the lower surface of the extension portion, and the drive module may travel below the extension portion so that the rotation shaft enters the guide portions.

In an aspect of the present disclosure, the container may include a first position detecting sensor provided on the extension portion or the container body, and the drive module may include a second position detecting sensor positioned to correspond to the first position detecting sensor, detecting a mutual position with the first position detecting sensor.

In an aspect of the present disclosure, first position detecting sensors may be provided on the lower surface of the extension portion and on the front surface or the rear surface of the container body, respectively, and multiple second position detecting sensors may be provided and positioned to correspond to the first position detecting sensors, aligning positions of the container and the drive modules.

In an aspect of the present disclosure, the container may include a first connecting module formed on the internal peripheral surface of the rotation shaft to penetrate an inside thereof in the upward/downward direction, and the drive module may include a second connecting module inserted into the first connecting module to connect the drive module and the container and a third actuator configured to move the second connecting module in the upward direction or the downward direction to be coupled to or decoupled from the first connecting module.

In an aspect of the present disclosure, the rotation shaft may be provided on front and rear sides of the container, and multiple drive modules are provided and connected to the front side and the rear side of the container to travel.

In an aspect of the present disclosure, the drive module may travel toward the container so that the rotation shaft enters the guide portions, and the magnetic modules may be held, after the rotation shaft enters the guide portions so that the container is moved through traveling.

A vehicle configured for container swapping according to an exemplary embodiment of the present disclosure is advantageous in that, in connection with a vehicle including a drive module which may be coupled to a container, the drive module may be freely coupled to and decoupled from a container through a magnetic module.

Furthermore, the container and the drive module may be electrically connected to each other so that by inputting a control signal or electric power to the drive module, traveling of the drive module is assisted.

Advantageous effects obtainable from the present disclosure may not be limited to the above mentioned effects, and other effects which are not mentioned may be clearly understood, through the following descriptions, by those skilled in the art to which the present disclosure pertains.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a perspective view of a vehicle configured for container swapping according to an exemplary embodiment of the present disclosure:

FIG. 2 is a side sectional view of a vehicle configured for container swapping according to an exemplary embodiment of the present disclosure:

FIG. 3 is a sectional view taken along A-A in FIG. 2:

FIG. 4 is a sectional view taken along B-B in FIG. 3:

FIG. 5 is a top view of a coupling space and a coupling body of a vehicle configured for container swapping according to an exemplary embodiment of the present disclosure:

FIG. 6 illustrates the movement of a magnetic module of a vehicle configured for container swapping according to an exemplary embodiment of the present disclosure;

FIG. 7 illustrates a coupling portion of a magnetic module coupling body of a vehicle configured for container swapping according to an exemplary embodiment of the present disclosure:

FIG. 8 is a perspective view of a drive module configured to hold a guide portion and a rotation shaft by a holding force from a magnetic module according to an exemplary embodiment of the present disclosure:

FIG. 9 illustrates the rotation shaft in FIG. 8, which enters the guide portion:

FIG. 10 is a perspective view of a drive module including multiple holding blocks to hold a guide portion and a rotation shaft according to an exemplary embodiment of the present disclosure:

FIG. 11 illustrates the rotation shaft in FIG. 10, which enters the guide portion;

FIG. 12 illustrates the guide portion and the rotation shaft in FIG. 10, which are held:

FIG. 13 illustrates upward/downward movements of a power module configured to provide a holding force to a magnetic module according to an exemplary embodiment of the present disclosure:

FIG. 14 illustrates area E in FIG. 13;

FIG. 15 illustrates area F in FIG. 13:

FIG. 16 illustrates the internal space of a rotation shaft according to an exemplary embodiment of the present disclosure; and

FIG. 17, FIG. 18, FIG. 19 and FIG. 20 illustrate connection between a rotation shaft and a power module through wires according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, embodiments included in the present specification will be described in detail with reference to the accompanying drawings, and the same or similar elements are provided the same and similar reference numerals, so duplicate descriptions thereof will be omitted.

The terms “module” and “unit” used for the elements in the following description are provided or interchangeably used in consideration of only the ease of writing the specification, and do not have distinct meanings or roles by themselves.

In describing the exemplary embodiments included in the present specification, when the detailed description of the relevant known technology is determined to unnecessarily obscure the gist of the present disclosure, the detailed description may be omitted. Furthermore, the accompanying drawings are provided only for easy understanding of the exemplary embodiments included in the present specification, and the technical spirit included herein is not limited to the accompanying drawings, and it should be understood that all changes, equivalents, or substitutes thereof are included in the spirit and scope of the present disclosure. Terms including an ordinal number such as “first”, “second”, or the like may be used to describe various elements, but the elements are not limited to the terms. The above terms are used only for distinguishing one element from another element.

In the case where an element is referred to as being “connected” or “coupled” to any other element, it should be understood that another element may be provided therebetween, as well as that the element may be directly connected or coupled to the other element. In contrast, in the case where an element is “directly connected” or “directly coupled” to any other element, it should be understood that no other element is present therebetween.

A singular expression may include a plural expression unless they are definitely different in a context.

As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

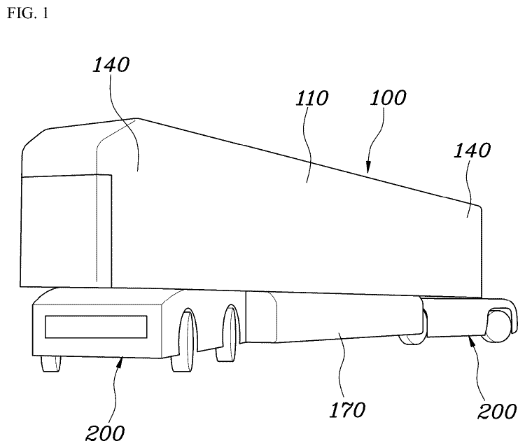

FIG. 1 is a perspective view of a vehicle configured for container swapping according to an exemplary embodiment of the present disclosure. FIG. 1 illustrates major components related to the exemplary embodiment, and it is obvious that more or fewer components may be included in connection with implementing an actual vehicle configured for container swapping.

Referring to FIG. 1, the container 100 may include a container body 110 having a loading space formed therein, and in front of or behind the container body 110, a rotation shaft 120 extending in the upward direction or the downward direction and a coupling body 130 configured to surround the rotation shaft 120.

The drive module 200 may include a vehicle driving device including wheels, a steering device, and a power module, moving the vehicle. Accordingly, the drive module 200 can travel independently, and may include an open coupling space 210 provided on a side surface thereof. As the drive module 200 travels toward the container 100, the coupling body 130 may be inserted into the open space. After the coupling body 130 is inserted into the open space, the magnetic module 220 provided in the open space may operate so that the coupling body 130 and the magnetic module 220 are fastened by a magnetic force. The drive module 200 may then travel to move the container 100 to a preset place. The drive module 200 may be manufactured to be able to travel autonomously or to be manually driven by a driver aboard.

After the container 100 is moved to the preset place, the drive module 200 and the container 100 are unfastened, and the drive module 200 may be fastened to another container 100. The magnetic module 220 facilitates fastening and unfastening in the instant case, and the drive module 200 can swap and move multiple drive modules 200.

The container 100 may include a bearing 180 provided between the rotation shaft 120 and the coupling body 130 which surrounds the rotation shaft 120 so that the coupling body 130 can rotate relative to the rotation shaft 120.

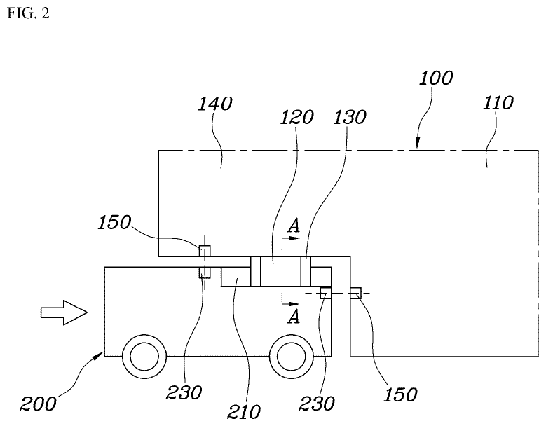

FIG. 2 is a side sectional view of a vehicle configured for container swapping according to an exemplary embodiment of the present disclosure.

Referring to FIG. 2, the container 100 may include an extension portion 140 formed to extend in the longitudinal direction on the upper portion of the front side or the rear side of the body of the container 100.

For the coupling body 130 formed as described above to be inserted into the coupling space 210, the drive module 200 may travel under the extension portion 140 to be fastened to the container 100. Accordingly, the radius of rotation occupied by the drive module 200 during rotating/traveling may be reduced, and the loading space may be expanded because cargo may be loaded up to the extension portion 140.

As illustrated in FIG. 2, the container 100 may include a first position detecting sensor 150 provided so that the position thereof may be detected, and the drive module 200 may include a second position detecting sensor 230 provided while being coupled to the container 100. Accordingly, the position of coupling between the drive module 200 and the container body 110 is identified, ensuring accurate coupling. Multiple first position detecting sensors 150 may be provided on the lower surface of the extension portion 140 and on the front surface or the rear surface of the container body 110. The second position detecting sensor 230 may detect the position of the container 100 and that of the drive module 200 while being on the upper and rear sides of the drive module 200. The second position detecting sensor 230 may detect leftward/rightward and forward/backward positions when the drive module 200 and the container body 110 are coupled, improving the accuracy of coupling between the drive module 200 and the container body 110.

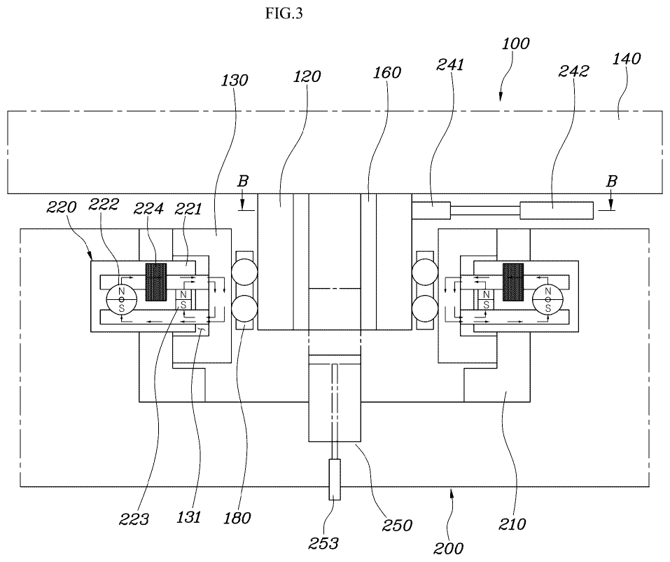

FIG. 3 is a sectional view taken along A-A in FIG. 2.

Referring to FIG. 3, the rotation shaft 120 may be provided on the front side or the rear side of the container 100. The rotation shaft 120 may be formed in the shape of a column extending in the upward direction or the downward direction thereof. The coupling body 130 may be coupled to the rotation shaft 120 to surround the rotation shaft 120. The rotation shaft 120 may be fixedly formed on the container 100 to extend downwards from the lower surface of the extension portion 140.

The coupling body 130 may be formed to surround an end-side external peripheral surface of the extension portion 140, and may be coupled to the rotation shaft 120 by a bearing 180 to be able to rotate with reference to the center portion extension line of the rotation shaft 120. Accordingly, the coupling body 130 rotates when the drive module 200 rotates/travels, reducing the radius of rotation.

The magnetic module 220 may include a module body 221 coupled to the coupling body 130, a rotatable magnetic body 222 rotatably coupled to the module body 221, a fixed magnetic body 223 fixed to the module body 221, and a coil 224 wound around the module body 221 and electrically connected thereto. The magnetic module 220 may include a magnetic circuit changed by the coil 224, being fastened to or unfastened from the coupling body 130.

The polarity of the electromagnet formed by the coil 224 may be changed by changing the direction of electric current flowing through the coil 224, rotating the rotatable magnetic body 222. Furthermore, the magnetic module 220 and the coupling body 130 may be fastened to or unfastened from each other by changing the magnetic circuit formed by the rotatable magnetic body 222 and the fixed magnetic body 223. An electric current can flow through the coil 224 only at the moment the rotatable magnetic body 222 is rotated, improving electric efficiency.

The container 100 may include a first connecting module 160 formed on the internal peripheral surface of the rotation shaft 120 to penetrate an inside thereof in the upward direction or the downward direction thereof. The drive module 200 may include a second connecting module 250 to be interconnected to the container 100 and a third actuator 253 configured to move the second connecting module 250 in the upward direction or the downward direction to be coupled to or decoupled from the first connecting module 160. The second connecting module 250 may be inserted into the rotation shaft 120 by the third actuator 253, and the drive module 200 and the container 100 may be fastened in the upward direction or the downward direction by the first connecting module 160 and the second connecting module 250.

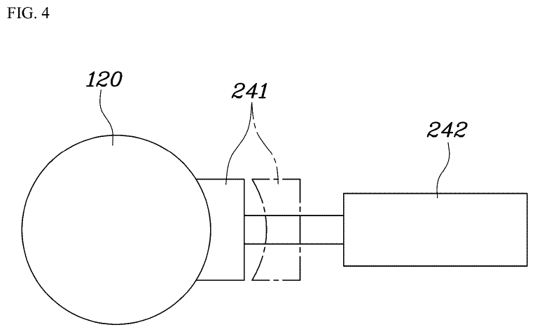

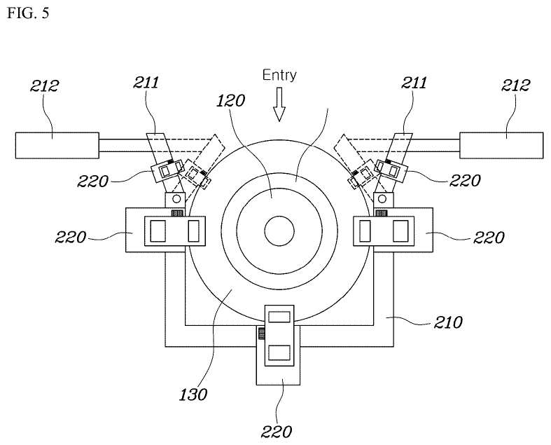

FIG. 4 is a sectional view taken along B-B in FIG. 3.

Referring to FIG. 4, the drive module 200 may include a contact portion 241 configured to contact with the rotation shaft 120 and a second actuator 242 configured to move the contact portion 241 to contact with the rotation shaft 120 or to separate therefrom.

When the drive module 200 and the container 100 travel straightly, the contact portion 241 contacts with the rotation shaft 120, improving stability, and when they rotate/travel, the contact portion 241 releases the contact.

FIG. 5 is a top view of a coupling space and a coupling body of a vehicle configured for container swapping according to an exemplary embodiment of the present disclosure.

Referring to FIG. 5, multiple magnetic modules 220 may be provided to be spaced from each other so that they are fastened in various directions. As multiple magnetic modules 220 are fastened to the coupling body 130 in various direction, the degree of fastening between the drive module 200 and the container 100 may be increased. The drive module 200 may include movable portions 211 which are rotatably coupled to both open side end portions of the coupling space 210, and on which magnetic modules 220 are disposed, respectively, and first actuators 212 for rotating the movable portions 211. When the coupling body 130 is inserted into the coupling space 210, the movable portions 211 may be rotated toward the coupling body 130 by the first actuators 212. After the first position detecting sensor 150 and the second position detecting sensor 230 confirm that the drive module 200 and the container 100 are aligned, the first actuators 212 may operate to rotate the movable portions 211 toward the coupling body 130. This prevents the coupling body 130 from detaching toward the open side of the coupling space 210.

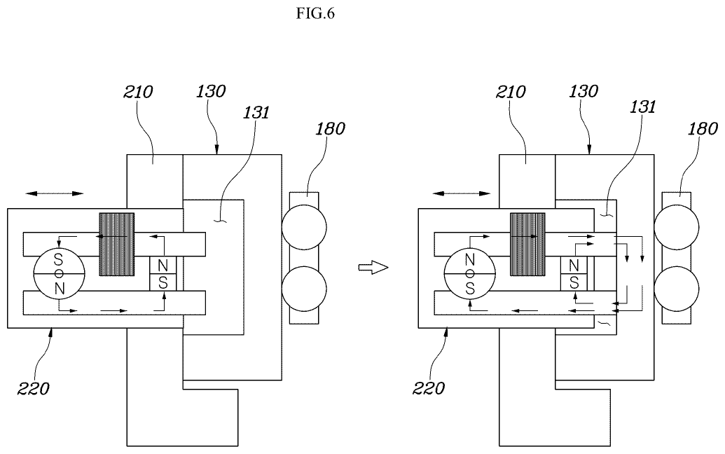

FIG. 6 illustrates the movement of a magnetic module of a vehicle configured for container swapping according to an exemplary embodiment of the present disclosure.

It is clear from FIG. 6 that the magnetic circuit changes depending on the magnetic field formed by the coil 224, and the magnetic module 220 and the coupling body 130 may be fastened by a magnetic force according to the direction of the magnetic circuit. The magnetic module 220 may protrude toward the inside of the coupling space 210 to be fastened to the coupling body 130 by the magnetic force.

The coupling body 130 may include a recessed portion 131 formed to be recessed from the external peripheral surface toward the center, and the magnetic module 220 may be inserted into the recessed portion 131 to be fastened to the coupling body 130. As illustrated in FIG. 6, the coupling body 130 may be formed in a shape of cylinder to surround the rotation shaft 120. This prevents the magnetic module 220 from moving in the upward direction or the downward direction thereof.

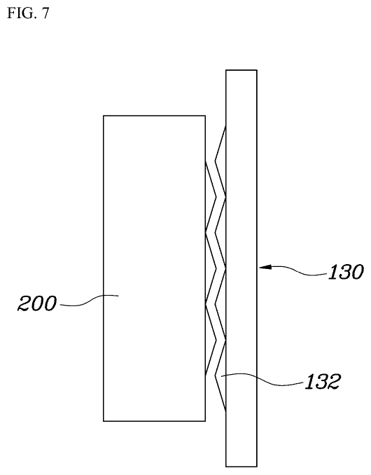

FIG. 7 illustrates a coupling portion of a magnetic module coupling body of a vehicle configured for container swapping according to an exemplary embodiment of the present disclosure.

Referring to FIG. 7, the recessed portion 131 may include a corrugated portion 132 formed on the internal surface thereof to protrude in the circumferential direction thereof. When the magnetic module 220 is fastened to the coupling body 130 so that a surface configured to contact with the corrugated portion 132 corresponds to the corrugated portion 132, the upward/downward fastening force may be increased. Multiple corrugated portions 132 may be formed to be spaced apart in the upward direction or the downward direction thereof.

As another exemplary embodiment of the above-described vehicle configured for container swapping, a drive module 200 may use a holding force from a magnetic module 220 to hold a guide portion 121 and a rotation shaft 120, moving a container 100 through traveling. This will be described in more detail.

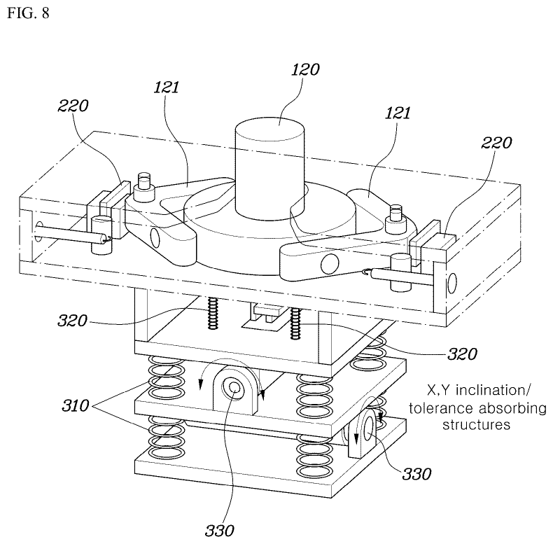

FIG. 8 is a perspective view of a drive module 200 configured to hold a guide portion 121 and a rotation shaft 120 by a holding force from a magnetic module 220 according to an exemplary embodiment of the present disclosure. FIG. 8 illustrates major components related to the exemplary embodiment, and it is obvious that more or fewer components may be included in connection with implementing an actual vehicle configured for swapping containers 100.

FIG. 8 illustrates guide portions 121 formed on the drive module 200. The guide portions 121 on both sides may guide the rotation shaft 120 of the container 100. When the drive module 200 travels toward the rotation shaft 120 of the container 100, the rotation shaft 120 enters the guide portions 121. The guide portions 121 may be formed in V-shapes so that both end portions thereof extend toward the rotation shaft 120, stably supporting the rotation shaft 120 from both sides. Magnetic modules 220 may be provided on peripheries around the guide portions 121. Multiple magnetic modules 220 may hold the guide portions 121 and the rotation shaft 120 by magnetic holding forces.

Springs 310 may be provided in the longitudinal direction of the rotation shaft 120 to elastically support the rotation shaft 120 upwards so that after the rotation shaft 120 enters the guide portions 121, the guide portions 121 and the rotation shaft 120 are not released by external impacts. A holding shaft 330 mounted in the drive module 200 may rotate in X-axis and Y-axis directions so that after the rotation shaft 120 enters the guide portions 121, tolerances in X-axis and Y-axis directions may be absorbed.

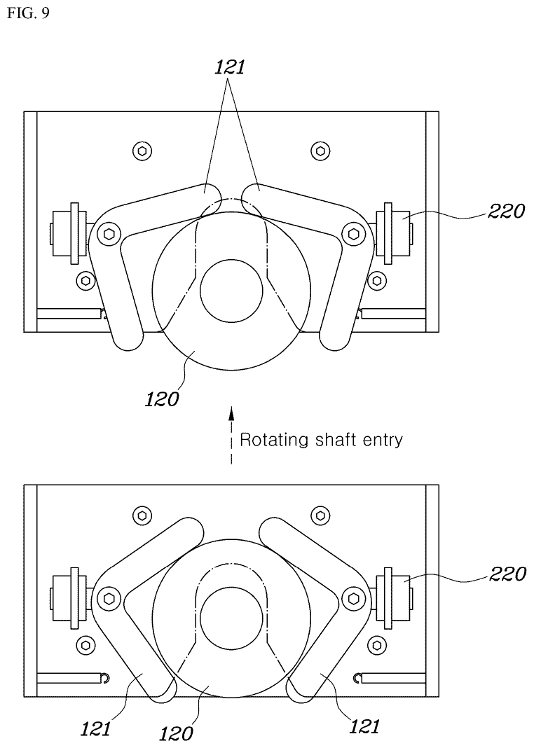

FIG. 9 illustrates the rotation shaft 120 in FIG. 8, which enters the guide portions 121.

Referring to FIG. 9, when the rotation shaft 120 enters the guide portions 121, the guide portions 121 may be pressurized by the rotation shaft 120 and thus rotated in a direction of entry of the rotation shaft 120. The rotation shaft 120 pressurizes one side of each guide portion 121. When the rotation shaft 120 has fully entered the guide portions 121, the guide portions 121 on both sides are held to face in the same direction thereof. Accordingly, when entering the guide portions 121, the rotation shaft 120 can reach the holding position accurately while being pressurized by lateral portions of the guide portions 121, facilitating coupling and decoupling between the drive module 200 and the container 100.

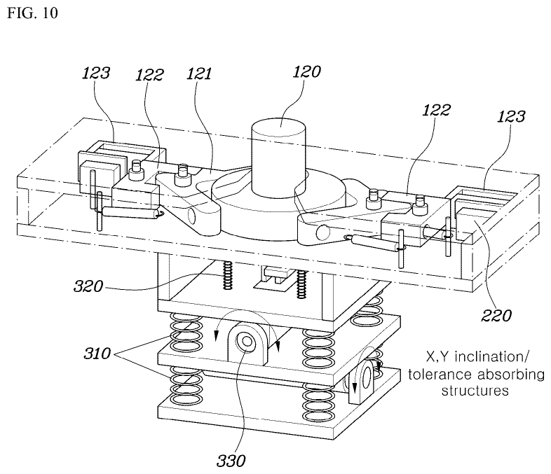

FIG. 10 is a perspective view of a drive module 200 having multiple holding blocks 122 and 123 to hold guide portions 121 and a rotation shaft 120 according to an exemplary embodiment of the present disclosure.

Referring to FIG. 10, the multiple holding blocks 122 and 123 may constrain the position of the guide portions 121 when the rotation shaft 120 enters the guide portions 121 and when the rotation shaft 120 has completely entered the same. Holding grooves may be formed on the rear surface of the guide portions 121. The holding grooves may be formed in step shapes to be able to engage with the holding blocks 122 and 123. While engaging with the holding grooves, the holding blocks 122 and 123 may be fastened and held by a holding force from the magnetic module 220.

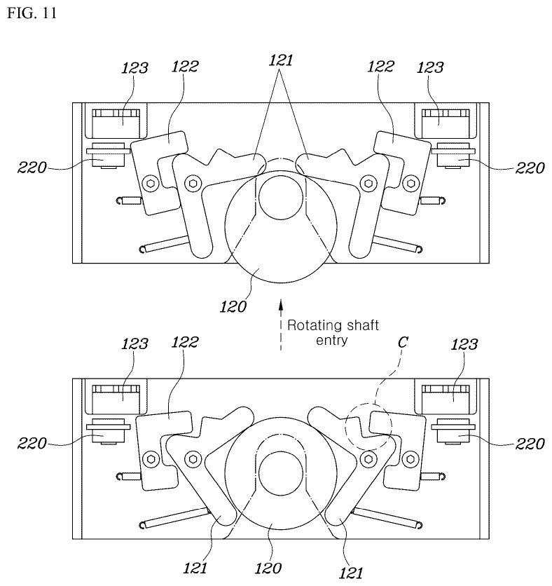

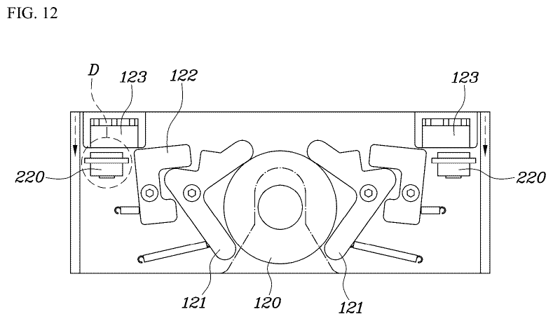

FIG. 11 and FIG. 12 will be referred to for more detailed description.

FIG. 11 illustrates the rotation shaft 120 in FIG. 10, which enters the guide portions 121. FIG. 12 illustrates the guide portion 121 and the rotation shaft 120 in FIG. 10, which are held.

The holding blocks 122 and 123 may be divided into a first holding block 122 and a second holding block 123. Referring to area C in FIG. 11, the first holding block 122 may be shaped to engage with a holding groove, constraining the position of a corresponding guide portion 121. Referring to area D in FIG. 12, the second holding block 123 may be provided behind the first holding block 122. When operated by holding forces from the magnetic modules 220 so that the guide portions 121 and the rotation shaft 120 are held, the first holding block 122 and the second holding block 123 engage in a twofold manner, keeping the guide portions 121 and the rotation shaft 120 stably held.

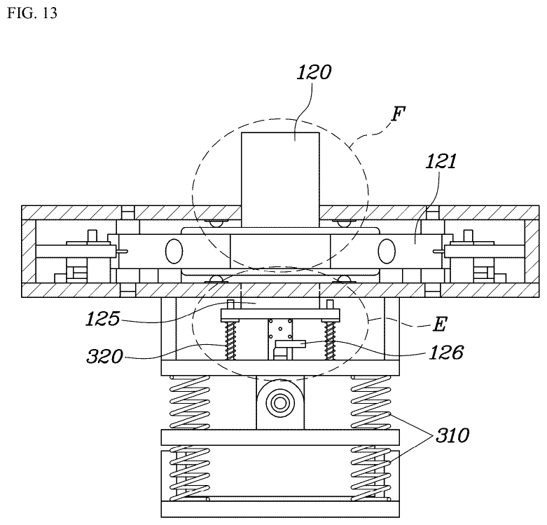

FIG. 13 illustrates upward/downward movements of a power module 125 configured to provide a holding force to a magnetic module 220 according to an exemplary embodiment of the present disclosure.

Referring to FIG. 13, when coupled to the rotation shaft 120, the power module 125 may ascend in the longitudinal direction of the rotation shaft 120, providing a holding force to the magnetic module 220. As a result of the upward/downward movement of the power module 125, the guide portions 121 and the rotation shaft 120 may be held or released. The power module 125 may be elastically supported upwards by multiple guide pins 320 provided on sides of the power module 125. The guide pins 320 constrain the upward/downward position of the power module 125 so that the guide portions 121 and the rotating 120 are stably held and released. A magnetic module 126 may be provided under the power module 125 so that the power module 125 provides a holding force to the magnetic module 220.

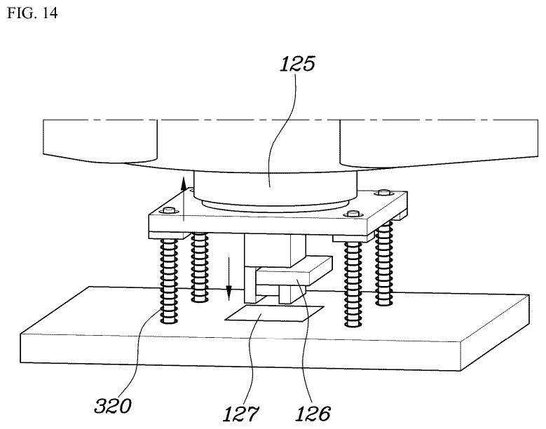

FIG. 14 illustrates area E in FIG. 13.

Referring to FIG. 14, when the power module 125 ascends in the longitudinal direction of the rotation shaft 120 to be coupled to the rotation shaft 120, and when the power module 125 is thus coupled to the rotation shaft 120, the magnetic module 126 may be decoupled from the armature 127 below the power module 125. The guide pins 320 then ascend in the longitudinal direction of the rotation shaft 120 to be coupled to the rotation shaft 120. On the other hand, when decoupled from the rotation shaft 120, the power module 125 may descend in the longitudinal direction of the rotation shaft 120 so that the guide portions 121 and the rotation shaft 120 are released. The magnetic module 126 then remains coupled to the armature 127 below the power module 125.

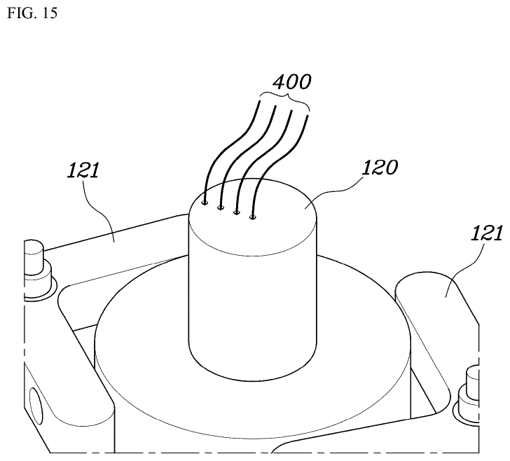

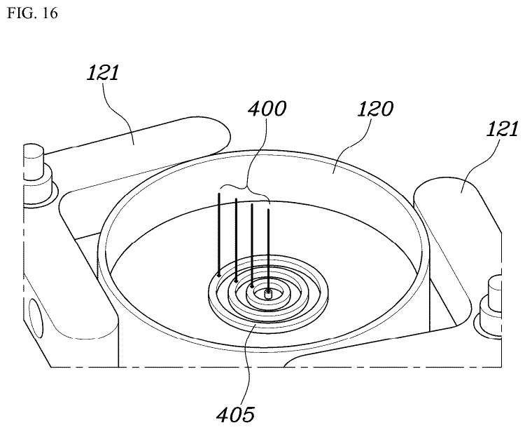

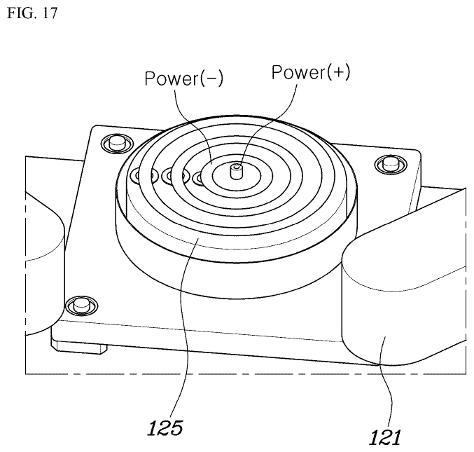

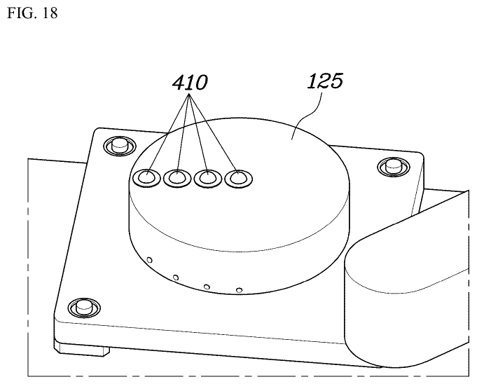

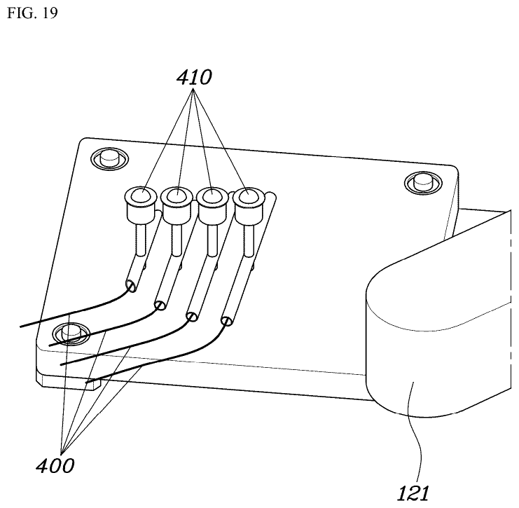

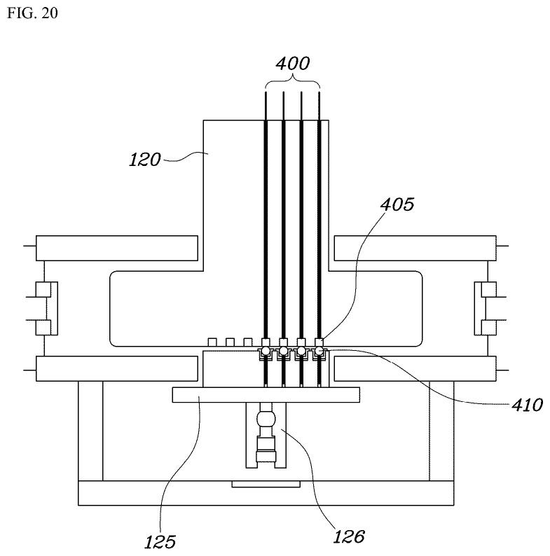

Configurations for power and signal connections between the container 100 and the drive module 200 will now be described with reference to FIG. 15, FIG. 16, FIG. 17, FIG. 18, FIG. 19 and FIG. 20.

FIG. 15 illustrates area F in FIG. 13. FIG. 16 illustrates the internal space of a rotation shaft 120 according to an exemplary embodiment of the present disclosure.

Referring to FIG. 15, the rotation shaft 120 may include an internal space formed therein, and wires 400 may penetrate the internal space. The wires 400 may include a power wire 400 and a CAN communication wire 400 so that power and signal connections between the container 100 and the drive module 200 are facilitated. The wires 400 that penetrate the internal space of the rotation shaft 120 may be drawn out through the lower surface of the rotation shaft 120 and connected to the power module 125. The internal space of the rotation shaft 120 will be described in more detail with reference to FIG. 16. Multiple copper foils 405 may be formed concentrically on the lower end portion of the internal space. The wires 400 may be connected to the power module 125 through the lower end portion of the internal space. This structure ensures that, when the power module 125 ascends in the longitudinal direction of the rotation shaft 120, the container 100 and the drive module 200 have power and signal connections therebetween, providing a holding force to the magnetic module 220.

FIG. 17, FIG. 18, FIG. 19 and FIG. 20 illustrate connection between a rotation shaft 120 and a power module 125 through wires 400 according to an exemplary embodiment of the present disclosure.

Referring to FIG. 17, the wires 400 may penetrate the lower end portion of the internal space of the rotation shaft 120 to be connected to the upper end portion of the power module 125. The power module 125 may have multiple concentric circles formed on the upper end portion thereof to correspond to the copper foils 405 on the lower end portion of the internal space of the rotation shaft 120. Respective concentric circles may be disposed so that minus (−) power and plus (+) power alternate. Referring to FIG. 18 to FIG. 20, the power module 125 may include an internal space formed therein, and wires 400 may be connected through passages in the internal space of the power module 125. The upper end portions of the wires 400 may be connected to the rotation shaft 120 through connecting joints 410 provided at the upper end portions of the passages. Technical features of the present disclosure will be clearly understood from FIG. 20 which is a longitudinal sectional view of the rotation shaft 120 and the power module 125 taken in the longitudinal direction of the rotation shaft 120.

According to various exemplary embodiments of the present disclosure described above, in connection with a vehicle including a drive module which may be coupled to a container, the drive module may be freely coupled to and decoupled from a container through a magnetic module. Furthermore, the container and the drive module may be electrically connected to each other so that by inputting a control signal or electric power to the drive module, traveling of the drive module is assisted.

According to various exemplary embodiments of the present disclosure, a controller is electrically connected to the drive module 200 such as the coil 224, actuators and sensors, but not limited thereto, to control the operations thereof.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the scope of the present disclosure includes software or machine-executable commands (e.g., an operating system, an application, firmware, a program, etc.) for facilitating operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle capable of container-swapping, the vehicle comprising:
a container including a container body and a rotation shaft provided on a front end portion or a rear end portion thereof; and
a drive module including a driving device to be able to travel, guide portions formed on a first side and a second side of the drive module, respectively, to guide the rotation shaft of the container, magnetic modules provided on peripheries around the guide portions, the drive module traveling toward the rotation shaft of the container so that the rotation shaft enters the guide portions, and the guide portions and the rotation shaft being held by a holding force from the magnetic modules so that the container is moved through traveling.

2. The vehicle of claim 1, wherein, when the rotation shaft enters the guide portions, the guide portions are pressurized by the rotation shaft and rotated in a direction of entry of the rotation shaft.

3. The vehicle of claim 1, wherein respective magnetic modules are provided on the peripheries around the guide portions to correspond to the guide portions.

4. The vehicle of claim 1, further including:
a power module provided on the drive module to ascend in a longitudinal direction of the rotation shaft when being coupled to the rotation shaft, providing the holding force to the magnetic modules,
wherein the power module is decoupled to an armature below the power module when coupled to the rotation shaft.

5. The vehicle of claim 4, wherein the power module descends with the guide portions in the longitudinal direction of the rotation shaft when decoupled from the rotation shaft so that the guide portions and the rotation shaft are released from each other.

6. The vehicle of claim 4, wherein the rotation shaft includes an internal space formed therein, a wire is provided to penetrate the internal space, and the penetrating wire is connected to the power module on a lower surface of the rotation shaft.

7. The vehicle of claim 4, further including:
a plurality of guide pins provided on lateral portions of the power module to elastically support the power module upwards,
wherein the guide pins are configured so that the power module ascends in the longitudinal direction of the rotation shaft to be coupled to the rotation shaft.

8. The vehicle of claim 4, further including a spring provided in the longitudinal direction of the rotation shaft to elastically support the rotation shaft upwards so that after the rotation shaft enters the guide portions, the guide portions and the rotation shaft are not released by external impacts.

9. The vehicle of claim 4, further including a holding shaft mounted in the drive module and configured to rotate in a first axis and a second d axis so that after the rotation shaft enters the guide portions, tolerances in the first axis and the second axis is absorbed.

10. The vehicle of claim 1, wherein the guide portions are formed in V-shapes so that first and second end portions thereof extend toward the rotation shaft.

11. The vehicle of claim 1, wherein the guide portions include holding grooves formed on rear surfaces thereof, and the vehicle further includes a plurality of holding blocks provided on peripheries around the guide portions to be fastened to the holding grooves formed on the guide portions by the holding force from the magnetic modules, constraining positions of the guide portions.

12. The vehicle of claim 1, wherein the container includes an extension portion formed to extend from an upper portion of a front side or a rear side of the container body, the rotation shaft extends downwards from a lower surface of the extension portion, and the drive module travels below the extension portion so that the rotation shaft enters the guide portions.

13. The vehicle of claim 12, wherein the container further includes a first position detecting sensor provided on the extension portion or the container body, and the drive module includes a second position detecting sensor positioned to correspond to the first position detecting sensor, detecting a mutual position with the first position detecting sensor.

14. The vehicle of claim 13,
wherein the drive module is in plural, a first position detecting sensor is in plural, and a second position detecting sensor is in plural, and
wherein the first position detecting sensors are provided on the lower surface of the extension portion and on a front surface or a rear surface of the container body, respectively, and the second position detecting sensors are provided and positioned to correspond to the first position detecting sensors, aligning positions of the container and the drive modules.

15. The vehicle of claim 1,
wherein the container includes a first connecting module formed on an internal peripheral surface of the rotation shaft to penetrate an inside thereof in upward and downward directions, and
wherein the drive module includes a second connecting module inserted into the first connecting module to connect the drive module and the container and an actuator configured to move the second connecting module in the upward direction or the downward direction to be coupled to or decoupled from the first connecting module.

16. The vehicle of claim 1,
wherein the drive module is in plural, and
wherein the rotation shaft is provided on a front side and a rear side of the container, and the drive modules are provided and connected to the front side and the rear side of the container to travel.

17. The vehicle of claim 1, wherein the drive module travels toward the container so that the rotation shaft enters the guide portions, and the magnetic modules are held, after the rotation shaft enters the guide portions so that the container is moved through traveling.

18. The vehicle of claim 1,
wherein the drive module includes a coupling body, and a recessed portion is formed in the coupling body to be recessed from an external peripheral surface thereof toward the center thereof, and
wherein the recessed portion includes a corrugated portion formed on an internal surface thereof to protrude in a circumferential direction thereof.
